(19) United States
(12) Patent Application Publication
(10) Pub. No.: US 2018/0290841 A1
(43) Pub. Date: Oct. 11, 2018

(54) SYSTEM FOR TRANSFERRING COMPONENTS OF DIFFERENT DESIGNS

(71) Applicant: Ford Global Technologies, LLC, Dearborn, MI (US)

(72) Inventors: Ibrahim CIFTCI, Koln (DE); Michel DANG, Cologne (DE); Catharina HENKELMANN, Anroechte (DE); Burkhard MINNER, Koln (DE); Sarah OTTEN, Koln (DE); Uwe ZWEBER, Kerpen (DE)

(73) Assignee: Ford Global Technologies, LLC, Dearborn, MI (US)

(21) Appl. No.: 15/924,598

(22) Filed: Mar. 19, 2018

(30) Foreign Application Priority Data
Apr. 10, 2017 (DE) 102017206136.7

(51) Int. Cl. B65G 47/90; B65G 57/00; B65G 59/00

(52) U.S. Cl. CPC B65G 47/90; B65G 59/00; B65G 57/00

(57) ABSTRACT

The present disclosure provides a system for transferring components of different designs, in particular vehicle components, from one processing station to a production line or further processing station. The system includes at least one transfer unit with at least one holding unit and a plurality of holding elements fixed on the holding unit such that at least one receptacle is formed between them. In order to automate the transfer of the components from the processing station to the production line or further processing station, the system further includes at least one loading unit to mechanically stack the components in the receptacle formed between the holding elements, and at least one unloading unit to mechanically unload the components stacked in the receptacle from the transfer unit and introduce the unloaded components into the production line or into the further processing station.

### CROSS-REFERENCE TO RELATED APPLICATIONS

This application is claims priority to and the benefit of DE 102017206136.7 filed on Apr. 10, 2017. The disclosure of the above application is incorporated herein by reference.

### FIELD

The present disclosure relates to a system for transferring components of different designs, in particular vehicle components, from at least one processing station to at least one production line or to at least one further processing station.

### BACKGROUND

The statements in this section merely provide background information related to the present disclosure and may not constitute prior art.

There is a known practice in motor vehicle production of imparting a desired shape to sheet-metal parts in a processing station in the form of a pressing plant and then feeding these processed components to a production line or to a further processing station in accordance with a supply chain of the motor vehicle production process. For this purpose, the components must be transferred from the pressing plant to the production line or to the further processing station.

To transfer the components from the pressing plant to the production line or to the further processing station, the components are deposited on transfer units in the form of transfer frames or transfer pallets, and these are then transferred, either directly or after temporary storage, from the pressing plant to the production line or to the further processing station. The components are deposited on the conventional transfer units either in an unordered or an ordered way, the latter possibility conventionally being accomplished by means of transfer units specially adapted to the shape of the components to be transferred, which, in turn, requires production, procurement and storage of these specially designed transfer units. Owing to the wide variety of designs of the components to be transferred, each component shape necessitates the storage of correspondingly specially designed transfer units.

The stacking of components of identical design on a transfer unit is usually performed manually since automation of this process in the case of a large number of components and transfer units of different designs would be very expensive, even if it were technically possible at all, owing to complex boundary conditions. Manual handling of the components or manual stacking of the components on a transfer unit leads to additional demands on the design of the transfer units since the design must satisfy ergonomic requirements in respect of the loading of the transfer units with the components, in respect of the unloading of the components from the transfer units and in respect of the introduction of the unloaded components into the production line or the further processing station.

U.S. Pat. No. 4,915,033 discloses a pallet for transferring components of different designs. The pallet comprises a base and a plurality of positioning pins, which can be fixed spaced apart at different positions on the base. The positioning pins can be arranged in such a way relative to one another in slots on the base that a receptacle for the positive reception of a stack of components of identical design is formed between them. Consequently, the pallet can be adapted to the shape of components of different designs, thus enabling components of different designs to be transferred with the pallet. Thus, just a single type of pallet has to be used to transfer the components of different designs.

EP 0 841 255 A2 relates to a device for the variable fixing of loaded material on a load carrier, which has a base plate with apertures for receiving fixing elements. The apertures are designed as uniformly spaced slots extending parallel to one another, in which the fixing elements can be moved and fixed, wherein the fixing elements each have a cylindrical upper clamping element, arranged above the base plate, for fixing the loaded material and a lower clamping element, arranged below the base plate, for fixing the upper clamping element. Thus, this device too can be adapted to components of different designs.

U.S. Pat. No. 7,044,066 discloses a pallet having a frame, a plurality of rails fixed on the frame, and a plurality of positioning pins, which can each be fixed at different positions along the respective rail. This pallet too can therefore be adapted to components of different designs.

### SUMMARY

The present disclosure provides a system to automate the transfer of components of different designs, in particular vehicle components, from at least one processing station to at least one production line or to at least one further processing station.

According to the present disclosure, the system includes at least one loading unit for the mechanized loading of the transfer unit with the components processed in the processing station, wherein the loading unit stacks the components in the receptacle formed between the holding elements, and which has at least one unloading unit for the mechanized unloading of the components stacked in the receptacle from the transfer unit and for the mechanized introduction of the unloaded components into the production line or the further processing station.

It should be noted that the features and measures presented individually in the following description can be combined in any technically worthwhile manner and give rise to further forms of the present disclosure. The description additionally characterizes and specifies the present disclosure, especially in conjunction with the figures.

The system, according to the present disclosure, allows the transfer of components of different designs, in particular vehicle components, from at least one processing station, in particular a pressing plant and/or stamping plant, to at least one production line or to at least one further processing station to be fully automated. The loading unit allows the components processed in the processing station to be loaded onto the standardized transfer units and stacked in the at least one receptacle formed between the holding elements of the respective transfer unit in a mechanized manner. The loaded transfer units are transferred to the production line or to the further processing station in an automated manner by at least one transfer robot, with or without temporary storage in a store, and the components stacked in the receptacles of the respective transfer unit are unloaded from the transfer units in a mechanized and automated manner by the unloading unit, and the unloaded components are introduced in a mechanized manner into the production line or the further processing station. Thus, fully automated material flow between the processing station and the production line or the further processing station can be implemented. An important feature for the implementation of this automated material flow are the transfer units of standardized design, which can be adapted in a simple manner to components of different designs produced by the processing station in order to enable the components of different designs to be transferred as described. In one form, the system comprises a plurality or a multiplicity of correspondingly designed transfer units. The components can be stacked in a vertical or horizontal direction in the respective receptacle between the holding elements, for example. However, other types of stacking are also possible, e.g. diagonal, oblique or transverse.

In the case of a vertical stack of components of identical design in the at least one receptacle formed between the holding elements, the holding unit of the transfer unit can form a deposition surface. The holding unit can be of at least partially pallet-type design in order to enable the transfer unit to be transferred by an industrial truck. In addition, the holding unit can be provided with bottom rollers or standing feet. The holding unit can have a reinforcing frame structure. The holding unit is produced at least partially from a metal, a metal alloy, a plastic or a composite material.

The holding elements can extend perpendicularly to the holding unit. The holding elements can be connected to the holding unit via a plug-in mechanism, with or without an additional securing mechanism. The holding elements can be arranged relative to one another on the holding unit in such a way that two or more receptacles are formed between them, wherein the receptacles can be of identical or different design to enable stacks of components of identical or different configuration to be accommodated therein. The holding elements can be designed as rectilinear holding pins or the like. The holding elements are produced at least partially from a metal, a metal alloy, a plastic or a composite material.

The loading unit can have at least one loading robot for the mechanized loading of the transfer unit or transfer units with the components processed in the processing station, said robot stacking the components in the receptacle or receptacles between the holding elements. The components processed by the processing station can be fed to the loading robot by a conveyor belt. The loading robot can be provided or combined with an optical system for detecting the spatial arrangement of a component lying on the conveyor belt which is to be grasped by the loading robot.

The unloading unit can have at least one unloading robot for the mechanized unloading of the individual components stacked in the receptacle or receptacles from the transfer unit or transfer units and for the mechanized introduction of the individual unloaded components into the production line or further processing station. The unloading unit can have at least one temporary store for the temporary storage of components which have been unloaded individually from the transfer unit or transfer units and deposited in the temporary store by an unloading robot of the unloading unit. The components stored in the temporary store can be removed individually from the temporary store and introduced into the production line or further processing station by the unloading robot in times in which no transfer unit is available or, alternatively, by a further additional unloading robot or of an assembly robot. The unloading robot can be provided or combined with an optical system for detecting the loading state of the temporary store.

To implement the automation of the transfer of components of different designs from a processing station to a production line or a further processing station, with or without temporary storage, as aimed for by the present disclosure, fewer transfer units are required, in comparison with the use of conventional transfer units of special and invariable design, by virtue of the design according to the present disclosure of the transfer unit or transfer units. As a result, the effort involved in transfer and a storage space for transfer units are reduced overall. By virtue of their ordered, rather than unordered, arrangement on the transfer unit, the components can furthermore be arranged with a higher component density on the transfer unit. The costs of the automation according to the present disclosure are relatively low in comparison with the use of conventional transfer units of special and invariable design. The structurally simple design of the transfer unit according to the present disclosure furthermore leads to reduced maintenance and repair costs.

According to an advantageous form, the holding unit comprises at least one holding plate, in which a multiplicity of apertures is formed, at least in some region or regions, wherein the holding elements are of rod-shaped design and each have an end section of reduced cross-sectional area, wherein the end sections are inserted positively into the respective apertures. According to this, the holding elements are connected to the holding plate by a plug-in mechanism, which allows simple arrangement of the holding elements on the holding plate. An encircling shoulder, which limits the insertion depth of the respective holding element, can be formed between the end section of reduced cross-sectional area and the remaining section of each holding element. By virtue of the positive engagement between the respective aperture and the end section, inserted therein, of the respective holding element, the holding element is fixed reliably on the holding plate. The holding elements are of rod-shaped design, in particular, the holding elements are of rectilinear design. The cross-sectional areas of the apertures in the holding plates correspond substantially to the cross-sectional areas of the end sections of the holding elements. The cross-sectional areas of the apertures in the holding plates are of identical design, according to one form. The cross-sectional areas of the end sections of the holding elements are of identical design, according to another form. The holding plate can also be provided with the apertures over the full area. The holding plate can be of level design and form a rectangular deposition surface, on which the components can be deposited. Two additional reference apertures can be formed in the holding plate, and these can be arranged in the opposite corner regions of the holding plate in the case of a holding plate of angular design, wherein the distances between the apertures and the reference apertures are known and can be used to calculate an enhanced arrangement of the holding elements on the holding plate, in particular to enable a plurality of component stacks to be arranged in a space-saving manner on the holding unit or the holding plate. As an alternative, however, it is also possible for existing apertures to be used as reference apertures.

It is advantageous if the holding elements are of cylindrical design. The holding elements can be of circular-cylindrical design, for example, or can have a polygonal cross-sectional area. The former possibility allows as gentle as possible contact between the holding elements and the components of a component stack situated between holding elements.

According to another advantageous form, the holding unit comprises at least two holding plates, which are arranged parallel and at a spacing from one another, in each of which a multiplicity of apertures is formed, at least in some region or regions, wherein the apertures in the holding plates are arranged in such a way as to be aligned with one another in pairs. The end section of a respective holding element is of a length such that it extends through one pair of mutually aligned apertures. In this way, the respective holding element is supported securely in position, in particular in a manner secure against tilting, in the holding plates. This form of the holding unit makes it possible to use two holding plates produced with relatively thin walls. This is associated with a weight saving over an individual holding plate produced with thick walls in comparison therewith. The holding plates can be held spaced apart by a holding structure of the holding unit.

According to another advantageous form, the system comprises at least one supporting unit, which can be fixed at different positions on the holding unit, for supporting at least one section of a stack of components of identical design inserted into the receptacle. The supporting unit can be of at least partially dimensionally stable design or of a design which is flexible to a certain extent. The latter possibility enables adaptation of the supporting unit to the respective shape of the components to be supported, wherein the supporting unit fits over a relatively large area against the component nearest to the supporting unit. The supporting unit can also support a stack inserted into the receptacle on the holding unit over the full area.

Another advantageous form envisages that the supporting unit has at least one fixing pin, which can be inserted positively into an aperture in the at least one holding plate. As a result, it is a simple matter for the supporting unit to be positioned in a variable manner on the holding unit in accordance with the holding elements and to be fixed on the holding unit in the respectively adopted position relative to said unit. It is also a simple matter to remove the supporting unit from the holding unit. In one form, the supporting unit comprises at least two corresponding fixing pins.

According to another advantageous form, the supporting unit has at least one rest for a stack of components of identical design, wherein the upper side of the rest corresponds substantially to a negative shape of the components. Using the rest enables the lowermost component of the stack to be held reliably, and hence enables the stack to be stabilized, even when the underside of the component is not of level or planar configuration. For this purpose, the lowermost component of the stack is placed in the rest in such a way that the contour of the underside of the component fits into the upper side of the rest, which is configured substantially like a negative shape of the component, giving rise to positive engagement.

It is furthermore advantageous if the holding elements are secured on the holding unit. For example, the holding elements can be secured positively and/or mechanically on the holding unit by a clip mechanism, a clamping mechanism, a latching mechanism or a shrinking process, for example. In the case of the shrinking process, the holding unit can be heated before the holding elements are arranged on the holding unit. Due to the contraction of the holding unit during the cooling of the holding unit, the holding elements are fixed securely on the holding unit. As an alternative or in addition, the holding elements can be connected materially to the holding unit, for example, by being adhesively bonded or welded to the holding unit after being arranged thereon. This form is advantageous particularly if, as described above, the holding unit has at least one holding plate with apertures into which the holding elements are inserted. The supporting unit can be secured in corresponding fashion, e.g. materially connected to the holding unit and/or mechanically secured on the holding unit.

According to another advantageous form, the system comprises at least one device for the mechanized or partially mechanized or manual fixing of the holding elements on the holding unit. In one form, the device is computer-controlled and arranges the holding elements on the holding unit on the basis of a result of a calculation of a space-saving and improved arrangement of the holding elements on the holding unit. The arrangement of the holding elements on the holding unit is thus known and can be fed electronically to the loading unit and/or the unloading unit, for example, in order to improve the operation of the loading unit and/or the unloading unit. In addition, the device can also be configured for the mechanized or partially mechanized or manual positioning and fixing of the supporting unit on the holding unit. The device can have at least one robot for the mechanized or partially mechanized or manual positioning and fixing of the holding elements and, optionally, of the supporting unit on the holding unit. Partially mechanized positioning and fixing can be performed in such a way, for example, that the device uses laser projection to indicate to an operator where the holding elements and/or the supporting unit are to be positioned and fixed.

It is advantageous if the system comprises at least one store for the temporary storage of the loaded transfer unit. The store can be designed as a high bay store or the like, for example, and is used to temporarily store, for a certain period of time, components which are not going to be introduced immediately into the production line or the further processing station.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 shows a schematic illustration of one illustrative form of a system according to the present disclosure;

FIG. 2 shows a schematic illustration of another illustrative form of a system according to the present disclosure;

FIG. 3 shows a schematic illustration of another illustrative form of a system according to the present disclosure;

FIG. 4 shows a schematic and perspective illustration of a transfer unit of another illustrative form of a system according to the present disclosure;

FIG. 5 shows a schematic and perspective illustration of a frame structure of the transfer unit shown in FIG. 4;

FIG. 6 shows a top schematic view of the transfer unit shown in FIGS. 4 and 5;

FIG. 7 shows a partial schematic and perspective illustration in of a holding unit of the transfer unit shown in FIGS. 4 to 6; and

FIG. 8 shows a schematic and perspective illustration of a holding element of the transfer unit shown in FIGS. 4 to 7.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

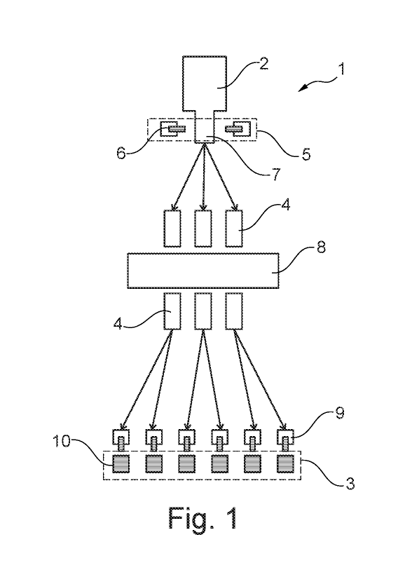

FIG. 1 shows a schematic illustration of one illustrative form of a system 1 according to the present disclosure for transferring components (not shown) of different designs, in particular vehicle components, from a processing station 2 in the form of a pressing plant or, alternatively, of a forging/casting/rolling/stamping plant to a production line 3.

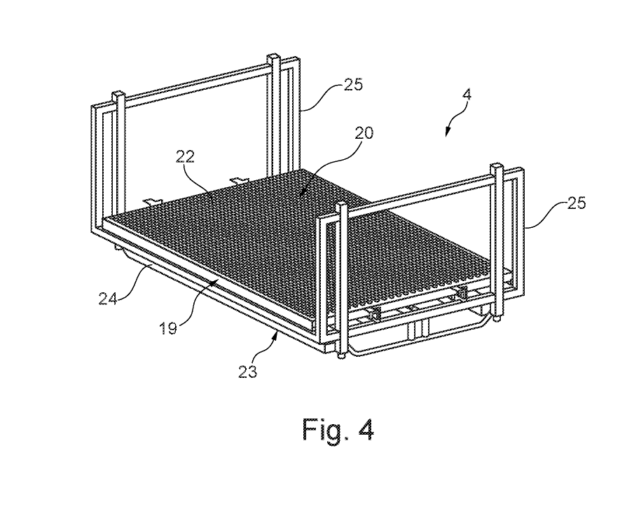

The system 1 has a plurality of transfer units 4, which each have a holding unit (not shown in FIG. 1) and a plurality of holding elements (not shown), which can be fixed spaced apart at different positions on the holding unit. The holding elements can be arranged relative to one another in such a way on the holding unit that at least one receptacle (not shown) for the positive reception of a stack (not shown) of components of substantially identical design is formed between them. The transfer units 4 can be designed in accordance with the transfer unit 4 shown in FIGS. 4 to 8, for example.

Each holding unit can have at least one holding plate (not shown), in which a multiplicity of apertures is formed, at least in some region or regions. The holding elements can be of rod-shaped design and can each have an end section of reduced cross-sectional area, wherein the end sections can be inserted positively into the respective apertures. The holding elements can be of cylindrical design. In particular, the holding unit can have at least two holding plates (not shown), which are arranged parallel and at a spacing from one another, in each of which a multiplicity of apertures is formed, at least in some region or regions, wherein the apertures in the holding plates are arranged in such a way as to be aligned with one another in pairs. The holding elements can be secured mechanically on the holding unit, for example, and/or can be connected materially to the holding unit or can simply be held in position by gravity. The apertures may define holes, and in one form are round holes.

The system 1 can furthermore have at least one supporting unit (not shown), which can be fixed at different positions on the holding unit, for supporting at least one section of a stack of components of substantially identical design inserted into the receptacle. The supporting unit can have at least one fixing pin (not shown), which can be inserted positively into an aperture in the at least one holding plate.

Moreover, the system 1 can have at least one device (not shown) for the mechanized or partially mechanized or manual positioning and fixing of the holding elements on the holding unit.

Furthermore, the system 1 comprises a loading unit 5 for the mechanized loading of the transfer units 4 with the components processed in the processing station 2. The loading unit 5 stacks the components in the at least one receptacle formed between the holding elements. For this purpose, the loading unit 5 has two loading robots 6, for example, which take the processed components from a conveyor belt 7, which conveys the processed components out of the processing station 2. The respective loading robot 6 then deposits the grasped component on a transfer unit 4.

The system 1 furthermore has a store 8 in the form of a high bay store for the temporary storage of loaded transfer units 4. For this purpose, the transfer units 4 loaded by the loading unit 5 are transferred from the loading station 5 to the store 8 and introduced into the latter by automatically or manually guided industrial trucks or tractors (not shown).

Furthermore, the system 1 has at least one unloading unit 9, and in one form, the system 1 includes a plurality of unloading units 9 in the form of unloading robots for the mechanized unloading of the components stacked in the receptacle from the transfer units 4 and for the mechanized introduction of the unloaded components into the correct station 10 of the production line 3. For this purpose, transfer units 4 temporarily stored in the store 8 are removed from the store 8 by automatically or manually guided industrial trucks or tractors (not shown) and transferred from the store 8 to the unloading units 9.

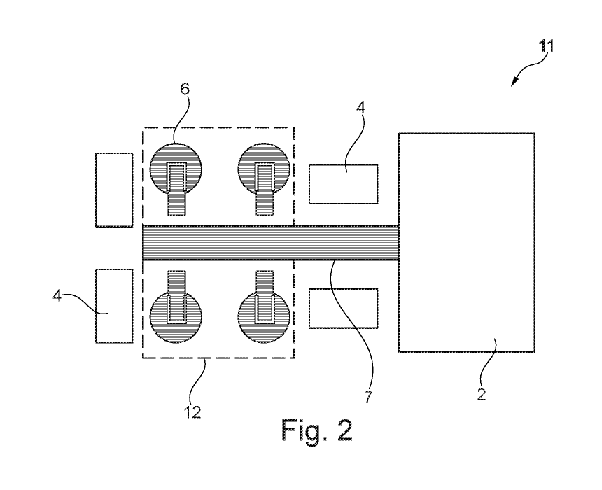

FIG. 2 shows a schematic illustration of another illustrative form of a system 11 according to the present disclosure for transferring components (not shown) of different designs, in particular vehicle components, from a processing station 2 in the form of a pressing plant or, alternatively, of a forging/casting/rolling/stamping plant to a production line (not shown) or to a further processing station (not shown).

The system 11 has a plurality of transfer units 4, which each have a holding unit (not shown) and a plurality of holding elements (not shown), which can be fixed spaced apart at different positions on the holding unit. The holding elements can be arranged relative to one another in such a way on the holding unit that at least one receptacle (not shown) for the positive reception of a stack (not shown) of components of similar design is formed between them. The transfer units 4 can be designed in accordance with the transfer unit 4 shown in FIGS. 4 to 8, for example.

Each holding unit can have at least one holding plate (not shown), in which a multiplicity of apertures is formed, at least in some region or regions. The holding elements can be of rod-shaped design and can each have an end section of reduced cross-sectional area, wherein the end sections can be inserted positively into the respective apertures. The holding elements can be of cylindrical design. In particular, the holding unit can have at least two holding plates (not shown), which are arranged parallel and at a spacing from one another, in each of which a multiplicity of apertures is formed, at least in some region or regions, wherein the apertures in the holding plates are arranged in such a way as to be aligned with one another in pairs. The holding elements can be secured mechanically on the holding unit, for example, and/or can be connected materially to the holding unit or can simply be held in position by gravity. The apertures may define holes, and in one form are round holes.

The system 11 can furthermore have at least one supporting unit (not shown), which can be fixed at different positions on the holding unit, for supporting at least one section of a stack of components of similar design inserted into the receptacle. The supporting unit can have at least one fixing pin (not shown), which can be inserted positively into an aperture in the at least one holding plate.

Moreover, the system 11 can have at least one device (not shown) for the mechanized or partially mechanized or manual positioning and fixing of the holding elements on the holding unit, if this device is not implemented at a separate station.

Furthermore, the system 11 comprises a loading unit 12 for the mechanized loading of the transfer units 4 with the components processed in the processing station 2. The loading unit 12 stacks the components in the at least one receptacle, formed between the holding elements, of the respective transfer unit 4. For this purpose, the loading unit 12 has four loading robots 6, for example, which take the processed components from a conveyor belt 7, which conveys the processed components out of the processing station 2. The respective loading robot 6 then deposits the grasped component on the nearest transfer unit 4 to the respective loading robot 6.

The system 11 can furthermore have a store (not shown) for the temporary storage of loaded transfer units 4. For this purpose, the transfer units 4 loaded by the loading unit 12 can be transferred from the loading unit 12 to the store and introduced into the latter by automatically guided industrial trucks (not shown).

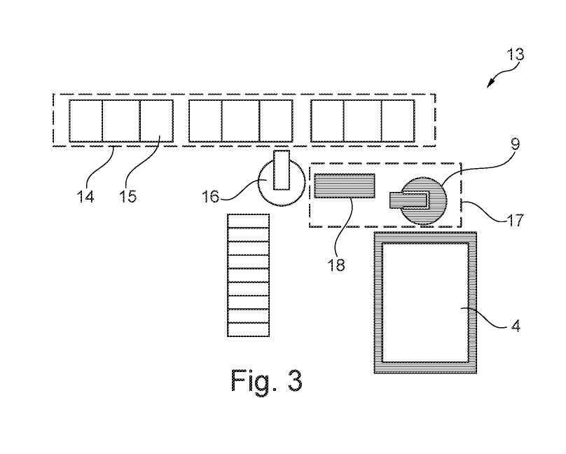

FIG. 3 shows a schematic illustration of another illustrative form of a system 13 according to the present disclosure for transferring vehicle components (not shown) of different designs from a processing station (not shown) in the form of a pressing plant to a production line 14 for body assembly. Bodies 15 are moved along the production line 13 and the components are attached to the bodies by an assembly robot 16.

The system 13 has one or more transfer units 4, each of which has a holding unit (not shown) and a plurality of holding elements (not shown), which can be fixed spaced apart at different positions on the holding unit. In FIG. 3, only one transfer unit 4 is shown. The holding elements can be arranged relative to one another in such a way on the holding unit that at least one receptacle (not shown) for the positive reception of a stack (not shown) of components of substantially identical design is formed between them. The transfer units 4 can be designed in accordance with the transfer unit 4 shown in FIGS. 4 to 8, for example.

Each holding unit can have at least one holding plate (not shown), in which a multiplicity of apertures is formed, at least in some region or regions. The holding elements can be of rod-shaped design and can each have an end section of reduced cross-sectional area, wherein the end sections can be inserted positively into the respective apertures. The holding elements can be of cylindrical design. In particular, the holding unit can have at least two holding plates (not shown), which are arranged parallel and at a spacing from one another, in each of which a multiplicity of apertures is formed, at least in some region or regions, wherein the apertures in the holding plates are arranged in such a way as to be aligned with one another in pairs. The holding elements can be connected positively to the holding unit, for example, and/or secured mechanically on the holding unit.

The system 13 can furthermore have at least one supporting unit (not shown), which can be fixed at different positions on the holding unit, for supporting at least one section of a stack of components of similar design inserted into the receptacle. The supporting unit can have at least one fixing pin (not shown), which can be inserted positively into an aperture in the at least one holding plate. The apertures may define holes, and in one form are round holes.

Moreover, the system 13 can have at least one device (not shown) for the mechanized or partially mechanized or manual positioning and fixing of the holding elements on the holding unit.

Furthermore, the system 13 has a loading unit (not shown) for the mechanized loading of the transfer units 4 with the components processed in the processing station. The loading unit stacks the components in the at least one receptacle, formed between the holding elements, of the respective transfer unit 4.

The system 13 can furthermore have a store (not shown) for the temporary storage of loaded transfer units 4. For this purpose, the transfer units 4 loaded by the loading unit can be transferred from the loading unit to the store and introduced into the latter by automatically guided industrial trucks (not shown).

Furthermore, the system 13 has an unloading unit 17 for the mechanized unloading of the components stacked in the at least one receptacle from the transfer units 4 and for the mechanized introduction of the unloaded components into the production line 14. For this purpose, transfer units 4 temporarily stored in the store can be removed from the store by automatically guided industrial trucks (not shown) and transferred from the store to the unloading unit 17. The unloading unit 17 comprises an unloading robot 9, which unloads the components from the transfer unit 4 by individually grasping the components situated on the transfer unit 4 and depositing them in a temporary store 18 of the unloading unit 17. The assembly robot 16 removes the components from the temporary store 18 and introduces them into the production line 14. The unloading robot 9 can be provided or combined with an optical system for detecting the loading state of the temporary store 18 to enable the unloading robot 9 to be appropriately controlled.

FIG. 4 shows a schematic and perspective illustration of a transfer unit 4 of another illustrative form of a system according to the present disclosure, of which only the transfer unit 4 is shown in FIG. 4. The system can be designed in accordance with one of the illustrative forms shown in FIGS. 1 to 3.

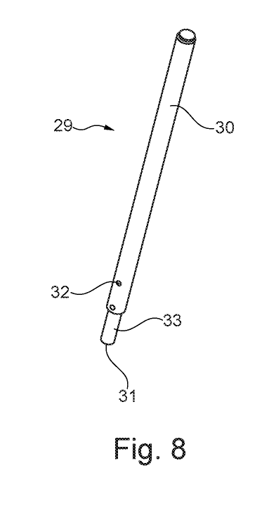

The transfer unit 4 comprises a holding unit 19 of cuboidal design and a plurality of holding elements (not shown in FIG. 4), which can be fixed spaced apart at different positions on the holding unit 19. The holding elements are designed in accordance with FIG. 8. The holding elements can be arranged relative to one another in such a way on the holding unit 19 that at least one receptacle (not shown) for the positive reception of a stack (not shown) of components of similar design is formed between them.

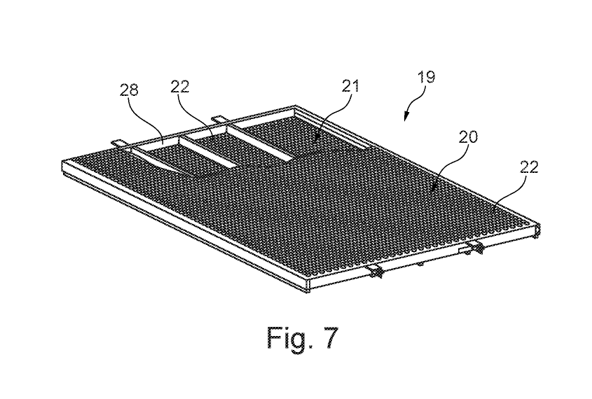

The holding unit 19 comprises two rectangular holding plates 20 and 21, which are arranged parallel and vertically spaced apart, wherein only the upper holding plate 20, which forms a deposition surface, is shown in FIG. 4. The other (lower) holding plate 21 is shown in FIG. 7. A multiplicity of apertures 22 is formed in each of the holding plates 20 and 21, wherein the apertures 22 in the holding plates 20 and 21 are arranged in such a way as to be aligned with one another in pairs. The apertures may define holes, and in one form are round holes. An end section of reduced cross-sectional area (not shown) of a holding element of rod-shaped and cylindrical design can be inserted positively into the respective pair of mutually aligned apertures 22. The holding elements can be connected positively to the holding unit 19, for example, and/or secured mechanically on the holding unit 19.

The transfer unit 4 can furthermore have at least one supporting unit (not shown), which can be fixed at different positions on the holding unit 19, for supporting at least one section of a stack of components of substantially identical design inserted into the receptacle. The supporting unit can have at least one fixing pin (not shown), which can be inserted positively into a pair of mutually aligned apertures 22 in the holding plates 20 and 21.

The transfer unit 4 furthermore has a frame structure 23, on which the holding unit 19 is fastened and on which a transfer appliance (not shown), e.g. an industrial truck, can engage in order to transfer the transfer unit 4. The frame structure 23 has a base section 24, which carries the holding unit 19, and two side wall sections 25, which are arranged on mutually opposite sides of the holding unit 19.

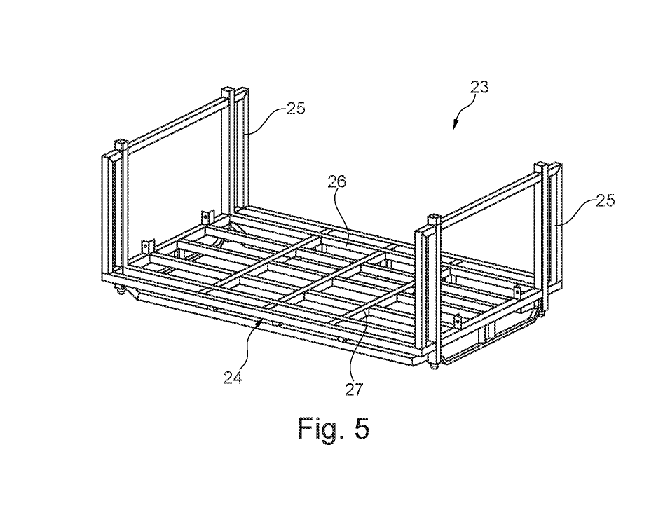

FIG. 5 shows a schematic and perspective illustration of the frame structure 23 of the transfer unit 4 shown in FIG. 4. The base section 24 is formed from a plurality of interconnected frame elements 26 and 27.

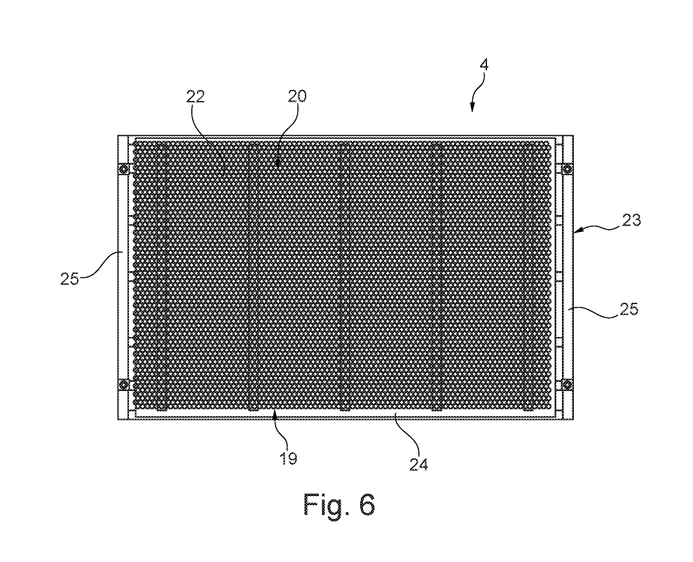

FIG. 6 shows a schematic view from above of the transfer unit 4 shown in FIGS. 4 and 5. In particular, it can be seen that the apertures 22 of the holding plates 20 and 21 are arranged in mutually aligned pairs, allowing the base section 24 of the frame structure 24 to be seen through the apertures 22.

FIG. 7 shows a schematic and perspective illustration in partial section of the holding unit 19 of the transfer unit 4 shown in FIGS. 4 to 6. The upper holding plate 20 is shown partially removed, allowing parts of the lower holding plate 21 to be seen. The holding unit 19 has a frame module 28, on which the holding plates 20 and 21 are fastened and which holds the holding plates 20 and 21 parallel and spaced apart. Moreover, the holding unit 19 can be fastened via its frame module 28 to the frame structure 23 shown in FIG. 5.

FIG. 8 shows a schematic and perspective illustration of a holding element 29 of the transfer unit shown in FIGS. 4 to 7. The holding element 29 comprises a hollow-cylindrical sleeve 30 and a rod 31 extending axially through the sleeve 30. The illustrated relative position of the sleeve 30 and the rod 31 is secured by two mechanical securing elements 32, which are welded, for example. The exposed end section of the rod 31, which is shown at the bottom in FIG. 8, forms the end section 33 of reduced outside diameter of the holding element 29. The end section 33 is inserted into a pair of mutually aligned apertures in the holding plates of the holding unit shown in FIG. 7.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A system for transferring components of different designs, in particular vehicle components, from at least one processing station to at least one production line or to at least one further processing station, the system comprising:
at least one transfer unit including at least one holding unit and a plurality of holding elements fixed and spaced apart at different positions on the holding unit, wherein the holding elements are arranged relative to one another such that at least one receptacle is formed between the holding elements for positive reception of a stack of components;
at least one loading unit operable to mechanically load the at least one transfer unit by stacking the components in the receptacle formed between the holding elements of the transfer unit; and
at least one unloading unit operable to mechanically unload the components stacked in the receptacle of the transfer unit and mechanically introduce the unloaded components into the production line or into the further processing station.

2. The system as claimed in claim 1, wherein the holding unit includes at least one holding plate defining a plurality of apertures formed in at least one region of the holding plate.

3. The system as claimed in claim 2, wherein the holding elements are rod-shaped and each holding element having a reduced cross-sectional end section configured to be positively inserted into a respective aperture of the at least one holding plate.

4. The system as claimed in claim 2, wherein the plurality of apertures of the at least one holding plate are holes.

5. The system as claimed in claim 2, wherein the plurality of apertures of the at least one holding plate are round holes.

6. The system as claimed in claim 1, wherein the holding elements are cylindrical.

7. The system as claimed in claim 1, wherein the holding unit includes at least two holding plates arranged parallel and vertically spaced from one another, each holding plate defining a plurality of apertures formed in at least one region, wherein the plurality of apertures of the at least two holding plates are aligned with one another in pairs.

8. The system as claimed in claim 1 further comprising at least one supporting unit, configured to be fixed at different positions on the holding unit, for supporting at least one section of the stacked components in the receptacle.

9. The system as claimed in claim 8, wherein the supporting unit includes at least one fixing pin configured to be positively inserted into an aperture of at least one holding plate of the holding unit.

10. The system as claimed in claim 8, wherein the supporting unit includes at least one rest, the rest having an upper side that corresponds to a negative shape of the stacked components.

11. The system as claimed in claim 1, wherein the holding elements are securely connected in position to the holding unit.

12. The system as claimed in claim 1, wherein the holding elements are mechanically secured on the holding unit.

13. The system as claimed in claim 1 further comprising at least one device operable to mechanically position and fix the holding elements on the holding unit.

14. The system as claimed in claim 1 further comprising at least one store to temporarily store the at least one loaded transfer unit.

15. A system for transferring components from at least one processing station to at least one production line or subsequent processing station, the system comprising:
at least one transfer unit including at least one holding unit and a plurality of holding elements fixed on the at least one holding unit such that at least one receptacle is formed between the plurality of holding elements;
at least one loading unit including at least one loading robot operable to mechanically stack the components in the at least one receptacle of the at least one transfer unit; and
at least one unloading unit including at least one unloading robot operable mechanically unload and transfer the components from the at least one transfer unit to the production line or subsequent processing station.

16. The system as claimed in claim 15, wherein each loading robot of the at least one loading unit and each unloading robot of the at least one unloading unit includes an optical system.

17. The system as claimed in claim 15, wherein the at least one unloading unit further includes a temporary store.

18. The system as claimed in claim 15, wherein the at least one holding unit includes at least one holding plate defining a plurality of apertures in at least one region of the holding plate, wherein a reduced cross-sectional end section of each holding element of the plurality of holding elements are inserted into one of the plurality of apertures.

19. The system as claimed in claim 15, wherein the at least one holding unit includes an upper holding plate and a lower holding plate, the upper holding plate including a plurality of apertures that are aligned with a plurality of apertures of the lower holding plate in pairs.

20. The system as claimed in claim 15, wherein the at least one transfer unit further includes a frame having a plurality of interconnecting frame elements that form a base section and at least two opposing side wall sections extending from the base section.
